(19) United States
(12) Patent Application Publication
(10) Pub. No.: US 2023/0052412 A1
(43) Pub. Date: Feb. 16, 2023

(54) CHOOSING DESIRED PRICE FOR PRODUCT ON PROMOTIONAL WEB PAGE

(71) Applicants: WEBIOTREE CO., LTD., Seoul (KR); VITABRID, INC., San Jose, CA (US)

(72) Inventor: Hojun Kim, Seoul (KR)

(21) Appl. No.: 17/870,131

(22) Filed: Jul. 21, 2022

Related U.S. Application Data
(63) Continuation-in-part of application No. 17/398,921, filed on Aug. 10, 2021, now abandoned.

(51) Int. Cl. G06Q 30/02

(52) U.S. Cl. CPC G06Q 30/0255; G06Q 30/0201; G06Q 30/0277

(57) ABSTRACT

A computer system, including: a downloadable application to operate on a mobile device of a customer, the downloadable application including instructions to browse and select items on web pages of an online seller, wherein the downloadable application enables the customer to select a desired price for a promotional product of the online seller; a consumer service provider in communication with the downloadable application of the mobile device, the consumer service provider to promote the promotional product of the online seller.

### CROSS-REFERENCE TO RELATED APPLICATIONS

This application is a continuation-in-part application of U.S. patent application Ser. No. 17/398,921, filed Aug. 10, 2021, entitled “Choosing Desired Price for Product on Promotional Web Page.” The disclosure of the above-referenced application is incorporated herein by reference.

### BACKGROUND

### Field

The present disclosure relates to methods and systems for e-commerce pricing, and more specifically, to enable customers to choose a desired price for a product on a promotional web page.

### Background

With increased online shopping, competition among online sellers is increasing with proliferation of price comparison sites that offer lowest prices for products selected by online shoppers. Thus, the online sellers may be searching for different ways to promote the products.

### SUMMARY

The present disclosure provides for an e-commerce pricing which enable the customers to select a desired price for a product on a promotional web page.

In one implementation, a method for an online seller to enable a customer to select a desired price of one or more products is disclosed. The method includes: sending an advertisement banner or link to a select customer; directing the select customer to a promotional web page when the select customer receives the advertisement banner or link, and clicks on it; and promoting the one or more products by enabling the select customer to select the desired price for one or more promotional products shown on the promotional web page.

In one implementation, the advertisement banner or link is sent to the select customer using an email. In one implementation, sending an advertisement banner or link includes placing the advertisement banner or link in an account of the select customer, wherein when the select customer signs into the account, the select customer finds the advertisement banner or link. In one implementation, the online seller has customer information including shopping habits of the select customer so that the advertisement banner or link is tailored specifically for the select customer. In one implementation, the method further includes placing a time limit on the promotion of the one or more products so that the time limit applies to when the select customer may select the advertisement banner or link. In one implementation, the promotional web page is separate and external from a main website of the online seller, but is connected to database of the online seller. In one implementation, the database of the online seller includes information about the select customer including payment data. In one implementation, the select customer is enabled to select the desired prices at a determined amount above a certain minimum and use the determined amount to donate to a charity. In one implementation, the select customer is enabled to select the desired prices at a determined amount above a certain minimum and direct the determined amount to a personal account of the select customer within an online seller system. In one implementation, the promotional web page is exclusively provided, at least one of: (1) to a particular area or age; and (2) through an exclusive media.

In another implementation, another method for an online seller to enable a customer to select a desired price of a product is disclosed. The method includes: placing an advertisement banner or link for a select customer within a website of the online seller such that when the select customer signs into a personal account of the select customer in the website, the select customer finds the advertisement banner or link; directing the select customer to a promotional web page when the select customer clicks on the advertisement banner or link; and enabling the select customer to select the desired price for one or more promotional products shown on the promotional web page.

In one implementation, the online seller has customer information including shopping habits of the select customer so that the advertisement banner or link is tailored specifically for the select customer. In one implementation, the method further includes placing a time limit on the promotion of the one or more products so that the time limit applies to when the select customer may select the advertisement banner or link. In one implementation, the promotional web page is separate and external from a main website of the online seller, but is connected to database of the online seller. In one implementation, the database of the online seller includes information about the select customer including payment data.

In another implementation, a computer system is disclosed. The computer system includes: a downloadable application to operate on a mobile device of a customer, the downloadable application including instructions to browse and select items on web pages of an online seller, wherein the downloadable application enables the customer to select a desired price for a promotional product of the online seller; a consumer service provider in communication with the downloadable application of the mobile device, the consumer service provider to promote the promotional product of the online seller by: processing shopping habits of customers who shop at the online seller; selecting at least one customer whose shopping habits match targets of the promotional product of the online seller; placing an advertisement banner or link for the promotional product within the web pages of the online seller such that when the at least one selected customer signs in, the at least one selected customer is directed to the web pages where the advertisement banner or link is placed; and enabling the at least one selected customer to select a desired price for the promotional product, wherein the desired price is any price above a lowest acceptable price set by the online seller for the promotional product.

In one implementation, the consumer service provider is a service provider, which manages and monitors the online purchases of the select customer through the connections of the mobile device. In one implementation, the consumer service provider is an application installed on the mobile device. In one implementation, the application provides the online seller with purchase status of the select customer, including information on what type of products the select customer buys and determine what type of promotional products the select customer likes to receive or purchase at discount. In one implementation, the advertisement banner or link is placed within a web page of the online seller such that when the select customer signs into the web page, the select customer finds the advertisement banner or link.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram of an e-commerce system for an online seller to enable customers to select a desired price for a product on a promotional web page in accordance with one implementation of the present disclosure;

FIG. 2 is a flow diagram of an e-commerce method for an online seller to enable customers to choose a desired price of a product on a promotional web page in accordance with one implementation of the present disclosure;

FIG. 3 is a flow diagram of an e-commerce method for an online seller to enable customers to choose a desired price of a product on a promotional web page in accordance with another implementation of the present disclosure;

FIG. 4A is a representation of a computer system and a user in accordance with an implementation of the present disclosure; and

FIG. 4B is a functional block diagram illustrating the computer system hosting an e-commerce application in accordance with an implementation of the present disclosure.

### DETAILED DESCRIPTION

As noted above, the price competition among online sellers are increasing and the online sellers are searching for different ways to promote their products.

Certain implementations of the present disclosure include several different ways for an online seller to enable customers to select a desired price for a product on a promotional web page. After reading the descriptions recited in this section, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

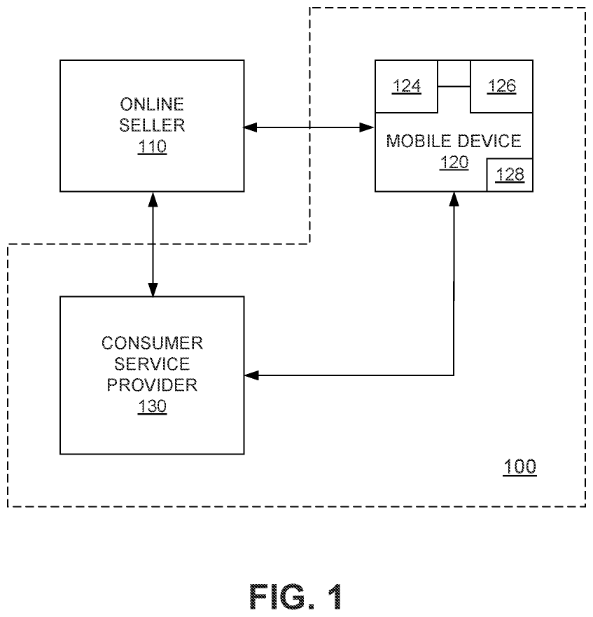

FIG. 1 is a block diagram of an e-commerce system 100 for an online seller to enable customers to select a desired price for a product on a promotional web page in accordance with one implementation of the present disclosure. The online seller may use the system 100 to promote one or more products by enabling a customer to select a price for the one or more products.

In the illustrated implementation of FIG. 1, the system 100 includes an interconnection of a mobile device 120 belonging to an online shopper or customer, and a consumer service provider 130. In one implementation, the system 100 interacts with an online seller 110. In one implementation, the online seller 110 uses the consumer service provider 130 to manage the customer information including the shopping habits and customer credit information. Thus, the consumer service provider 130 interfaces with the mobile device 120 of the customer to enable the customer to select the desired price for a product on a promotional web page.

In one implementation, the mobile device 120 is a mobile phone including a built-in camera and an interface port for connecting other communication devices. In another implementation, the mobile device 120 is a laptop computer including a built-in camera. In yet another implementation, the mobile device 120 is a desktop computer. Thus, in the case of the desktop computer, the device 120 is usually stationary.

In one implementation, the online seller 110 is an online merchant with fixed website address(es) having multiple pages of merchandises for sale on the Internet. The multiple pages may include a promotional web page to promote one or more products by enabling a customer to select a price for the one or more products. In another implementation, the online seller 110 is a private online distributor showing merchandises for sale at the request of the consumer.

In one implementation, the consumer service provider 130 is a service provider, which manages and/or monitors the online purchases of the customer through the connections of the mobile device 120, and provides the online seller 110 with the purchase status of the customer. For example, the purchase status may provide the online seller 110 with information on what type of products the customer buys and determine what type of promotional products the customer may like to receive or purchase at discount.

In another implementation, the consumer service provider 130 is an application installed on the mobile device 120. In one implementation, the mobile device 120 includes: an application performing the functions of the consumer service provider 130; a memory 124; a downloadable software module 128 that operates on the mobile device 120 to browse and select products from the online seller 110; and a processor 126 coupled to the memory 124 programmed with executable instructions. In one implementation, the application manages and/or monitors the online purchases of the online shopper made using the mobile device 120. In another implementation, the application also provides the online seller 110 with the purchase status of the online shopper, including information on what type of products the customer buys and determine what type of promotional products the customer may like to receive or purchase at discount.

In one implementation, the promotion involves the online seller 110 sending an advertisement banner or link to the mobile device 120 of the customer. In one implementation, the advertisement banner or link is sent to a select customer using an email. In another implementation, the advertisement banner or link is placed within the online seller's website such that when the customer signs into the online seller's website, the customer may find the advertisement banner or link. In either implementation, the online seller has the customer information, including shopping habits of the customer, provided by the consumer service provider 130. Thus, the advertisement banner or link may be directed at or tailored specifically for the customer to promote a new or different product of the online seller. In one implementation, certain condition(s) may apply to the promotion. For example, the condition may limit the customer to benefit from the promotion within a limited time (e.g., once a month, once a year, or once in a lifetime).

The advertisement banner or link may be connected to a promotional web page of the online seller so that when the select customer clicks on the banner or link, the customer would be directed to the promotional web page. In one implementation, although the promotional web page is separate and external from the main website of the online seller, the promotional web page is connected to the online seller's database, which includes customer information and payment data received from the consumer service provider 130.

In one implementation, the promotion can involve more than one promotional web page running at the same time. In one implementation, each promotional web page has different purpose or condition. In another implementation, each promotional web page has a different minimum price and/or different purchase conditions for the same product. Further, a promotional web page can be exclusively provided to a particular area or age, and/or through an exclusive media.

In the illustrated implementation of FIG. 1, the customer uses the mobile device 120 to browse the online shopping mall of the online seller 110 and selects items to buy. The mobile device 120 uses the downloadable software module 128, the memory 124, and the processor 126 to enable the customer to browse and select items to buy from the online seller 110.

In a further implementation, a computer system includes a downloadable application and a consumer service provider in communication with the downloadable application.

In one implementation, the downloadable application operates on a mobile device of a customer and includes instructions to browse and select items on web pages of an online seller, wherein the downloadable application enables the customer to select a desired price for a promotional product of the online seller.

In one implementation, the consumer service provider is in communication with the downloadable application of the mobile device. In one implementation, the consumer service provider promotes the promotional product of the online seller by: processing shopping habits of customers who shop at the online seller; selecting at least one customer whose shopping habits match targets of the promotional product of the online seller; placing an advertisement banner or link for the promotional product within the web pages of the online seller such that when the at least one selected customer signs in, the at least one selected customer is directed to the web pages where the advertisement banner or link is placed; and enabling the at least one selected customer to select a desired price for the promotional product, wherein the desired price is any price above a lowest acceptable price set by the online seller for the promotional product.

In one implementation, the shopping habits of the customers who shop at the online seller are processed using a list of customers and ranking each customer by points into categories of items previously bought by each customer. In one implementation, the shopping habits of the customers are matched to the targets of the promotional product of the online seller by matching the promotional product for each customer with a highest point for each category of items. For example, for customer A in a bag category, brand A bag is selected as the promotional product, if brand A has the highest point for the bag category.

In one implementation, a desired price for the promotional product selected by the selected customer is accepted by the online seller, the desired price is any price above a lowest acceptable price set by the online seller for the promotional product. In this implantation, the lowest acceptable price is hidden from the selected customer and is only known to the online seller. In one implementation, the customer is given one opportunity to set the desired price. Thus, if the desired price is below the lowest acceptable price, the customer will not be able to purchase the promotional product. In another implementation, the number of bids allowable to the customer is set by the online seller. In a further implementation, the number of bids allowable to the customer is set by the consumer service provider.

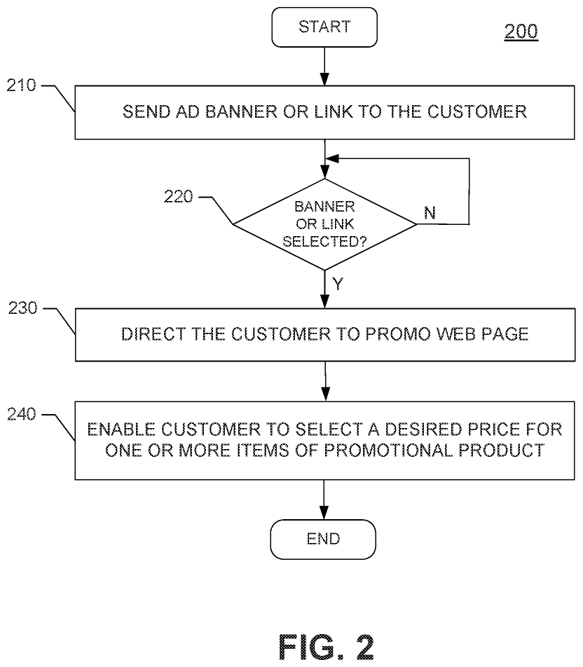

FIG. 2 is a flow diagram of an e-commerce method 200 for an online seller to enable customers to choose a desired price of a product on a promotional web page in accordance with one implementation of the present disclosure. In the illustrated implementation of FIG. 2, the online seller promotes one or more products by enabling a customer to select a price for the one or more products.

In one implementation, the promotion involves the online seller sending, at step 210, an advertisement banner or link to a customer. In one implementation, the advertisement banner or link is sent to a select customer using an email. In another implementation, the advertisement banner or link is placed within the online seller's website such that when the customer signs into the online seller's website, the customer may find the advertisement banner or link. In either implementation, the online seller has the customer information including shopping habits of the customer. Thus, the advertisement banner or link may be directed at or tailored specifically for the customer to promote a new or different product of the online seller. In one implementation, certain condition(s) may apply to the promotion. For example, the condition may limit the customer to benefit from the promotion within a limited time (e.g., once a month, once a year, or once in a lifetime).

The advertisement banner or link may be connected to a promotional web page of the online seller's main website so that when the select customer clicks on the banner or link, the customer would be directed to the promotional web page. In one implementation, although the promotional web page is separate and external from the main website of the online seller, the promotional web page is connected to the online seller's database, which includes customer information and payment data. In one implementation, when the customer receives or finds an advertisement banner or link, and clicks on it, at step 220, the customer is directed to the promotional web page, at step 230.

Then, at step 240, the online seller promotes one or more products by enabling a customer to select a desired price for the one or more promotional products. One of the main benefits for the online seller when the seller enables the customer to set a desired price is that it empowers the customer to take control. Rather than the online seller setting an arbitrarily low price for a product to promote it, the customer is enabled to set the desired price to any amount such that the customer can be empowered to set aside certain amount for any purpose. For example, the customer can set the price for the product at a determined amount above a certain minimum (e.g., $0) and use the determined amount to donate to a charity. In another example, the customer can set the price for the product at a determined amount above a certain minimum, and direct the determined amount to an account of the customer within the online seller's database so that the money in the account can be used later to buy a gift for an acquaintance of the customer. In yet another example, the customer can set the price for the product at a certain minimum and donate the product to a charity or person selected by the customer.

In one implementation, the promotion can involve more than one promotional web page running at the same time. In one implementation, each promotional web page has different purpose or condition. In another implementation, each promotional web page has a different minimum price and/or different purchase conditions for the same product. Further, a promotional web page can be exclusively provided to a particular area or age, and/or through an exclusive media.

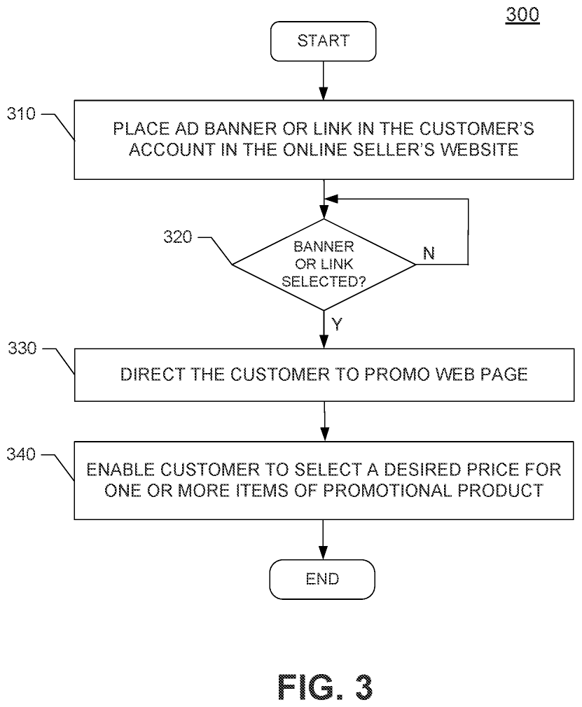

FIG. 3 is a flow diagram of an e-commerce method 300 for an online seller to enable customers to choose a desired price of a product on a promotional web page in accordance with another implementation of the present disclosure. In the illustrated implementation of FIG. 2, the online seller promotes one or more products by enabling a customer to select a price for the one or more products.

In one implementation, the promotion involves the online seller placing, at step 310, an advertisement banner or link within the online seller's website such that when the customer signs into the customer's account in the online seller's website, the customer may find the advertisement banner or link. In one implementation, the online seller has the customer information including shopping habits of the customer. Thus, the advertisement banner or link may be directed at or tailored specifically for the customer to promote a new or different product of the online seller. In one implementation, certain condition(s) may apply to the promotion. For example, the condition may limit the customer to benefit from the promotion within a limited time (e.g., once a month, once a year, or once in a lifetime).

The advertisement banner or link may be connected to a promotional web page of the online seller's main website so that when the select customer clicks on the banner or link, the customer would be directed to the promotional web page. In one implementation, although the promotional web page is separate and external from the main website of the online seller, the promotional web page is connected to the online seller's database, which includes customer information and payment data. Thus, the advertisement banner or link may be directed at or tailored specifically for the customer to promote a new or different product of the online seller.

In one implementation, when the customer finds a placed advertisement banner or link, and selects the banner or link, at step 320, the customer is directed to the promotional web page, at step 330. The customer is enabled, at step 340, to select a desired price for the one or more items of the promotional product. Thus, the customer can set the price for the product at any price to obtain the advertised/promotional product. As a promotional product, the online seller may give away the product for free. However, by letting the customer set the desired price, the customer is empowered to set his/her own price. In certain implementations, the customer requests to receive or direct to an entity (e.g., charitable organization) multiple items of the promotional product for a minimum price per item. This type of discount promotion may provide the online seller with exposure to goodwill of the community as well as brand loyalty of the customers.

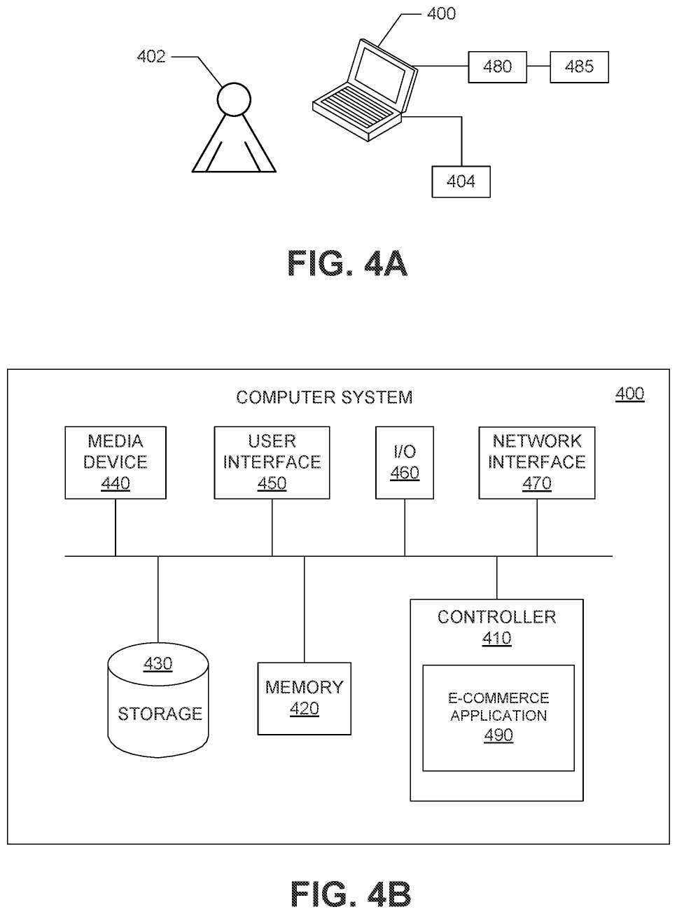

FIG. 4A is a representation of a computer system 400 and a user 402 in accordance with an implementation of the present disclosure. The user 402 uses the computer system 400 to implement an e-commerce application 490 as illustrated and described with respect to the system 100 in FIG. 1 and methods 200, 300 in FIGS. 2 and 3.

The computer system 400 stores and executes the e-commerce application 490 of FIG. 4B. In addition, the computer system 400 may be in communication with a software program 404. Software program 404 may include the software code for the e-commerce application 490. Software program 404 may be loaded on an external medium such as a CD, DVD, or a storage drive, as will be explained further below.

Furthermore, the computer system 400 may be connected to a network 480. The network 480 can be connected in various different architectures, for example, client-server architecture, a Peer-to-Peer network architecture, or other type of architectures. For example, network 480 can be in communication with a server 485 that coordinates engines and data used within the e-commerce application 490. Also, the network can be different types of networks. For example, the network 480 can be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the e-commerce application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system, such as to provide the data processing. In its execution, the controller 410 provides the e-commerce application 490 with a software system. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the e-commerce application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

In one implementation, the system 100 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 100 is configured with a combination of hardware and software.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A computer system, comprising:
a downloadable application to operate on a mobile device of a customer, the downloadable application including instructions to browse and select items on web pages of an online seller,
wherein the downloadable application enables the customer to select a desired price for a promotional product of the online seller;
a consumer service provider in communication with the downloadable application of the mobile device,
the consumer service provider to promote the promotional product of the online seller by:
processing shopping habits of customers who shop at the online seller;
selecting at least one customer whose shopping habits match targets of the promotional product of the online seller;
placing an advertisement banner or link for the promotional product within the web pages of the online seller such that when the at least one selected customer signs in, the at least one selected customer is directed to the web pages where the advertisement banner or link is placed; and
enabling the at least one selected customer to select a desired price for the promotional product,
wherein the desired price is any price above a lowest acceptable price set by the online seller for the promotional product.
